(19) United States
(12) Patent Application Publication
(10) Pub. No.: US 2026/0340894 A1
(43) Pub. Date: Oct. 29, 2026

(54) GENERATIVE MODEL-BASED GENERATION OF DESIGN CONSTRUCTS IN COMPUTING SYSTEMS

(71) Applicant: FIGMA, INC., San Francisco, CA (US)

(72) Inventor: Rogie Royal King, Murray, UT (US)

(21) Appl. No.: 19/187,741

(22) Filed: Apr. 23, 2025

(51) Int. Cl. G06T 11/60

(52) U.S. Cl. CPC G06T 11/60; G06T 2200/24

(57) ABSTRACT

Embodiments of the present disclosure provide techniques for generating and refining a design construct using a generative artificial intelligence model. An example method includes receiving a request to generate a design construct applicable to visual assets on a canvas in a design environment. The request specifies one or more visual properties of the design construct. The design construct is generated based on a generative artificial intelligence model configured to generate the design construct based on the specified one or more visual properties of the design construct. The design construct is deployed to the design environment.

### BACKGROUND

### Field of the Various Embodiments

Embodiments of the present disclosure relate generally to graphic design tools and, more specifically, to techniques for generating reusable design constructs in a graphic design tool using generative artificial intelligence models.

### Description of the Related Art

Generative artificial intelligence models can be used to generate a variety of content, such as textual content, image content, or the like. To generate content, a generative artificial intelligence model generally ingests an input prompt specifying parameters of the content to be generated, and the generative artificial intelligence model outputs content according to the parameters. These generative artificial intelligence models can ingest an input prompt including data in any of a variety of data modalities and output a response in one or more data modalities based on the application for which the generative artificial intelligence models are trained. Diffusion models can generate image output(s) from an input prompt (which may be a textual prompt, a multimodal prompt including data in a plurality of modalities such as text, image data, audio data, etc.), while language models can generate textual responses to input prompts.

In graphical design software, visual assets may be rendered and designed on a canvas using design constructs. A visual asset, as used herein, may be a group of visual components rendered in a user interface. Visual assets may be vector assets defined in terms of mathematical relationships between different components or raster assets defined in terms of absolute pixel locations. In some cases, a visual asset may include one or more containers, defined in the vector space, in which raster assets (e.g., images) can be inserted.

A design construct, as used herein, may be a design tool or design style that can be applied on a canvas in the graphical design software to create a new visual asset or modify an extant visual asset. Examples of a design construct include a paintbrush, a pen, a pencil, etc. In many cases, “out of the box” design constructs in the graphical design software may not allow for the creation of visual assets with a desired visual appearance. For example, a visual appearance of brush strokes painted with a paintbrush with a particular tip size on a particular textured surface may be desired. In such cases, a custom design construct is created to achieve the desired visual appearance. However, the process of creating a custom design construct is often a multi-step process that undergoes multiple iterations before the custom design construct is finalized. Such a multi-step process may involve the extensive use of computing resources to capture an image of iteration of a design, generate a design construct from the captured image, test the design construct, and modify the image of the design for ingestion into a computing system again. Generating a design construct may thus involve forward iteration and trackbacks to previously generated design constructs, each iteration of which may involve the use of computing resources for various computationally expensive graphic manipulation tasks.

As the foregoing illustrates, what is needed are more effective techniques for generating custom design constructs.

### SUMMARY

One embodiment of the present disclosure provides techniques for generating and refining a design construct using a generative artificial intelligence model. An example method includes receiving a request to generate a design construct applicable to visual assets on a canvas in a design environment. The request specifies one or more visual properties of the design construct. The design construct is generated based on a generative artificial intelligence model configured to generate the design construct based on the specified one or more visual properties of the design construct. The design construct is deployed to the design environment.

One technical advantage of the disclosed techniques relative to the prior art is that the disclosed techniques allow for efficient generation and refinement of reusable design constructs in a design environment. Because reusable design constructs can be efficiently generated and refined using generative artificial intelligence models, embodiments presented herein can significantly reduce the amount of compute resources (e.g., GPU/CPU cycles, memory, etc.) used in generating design constructs through repeated imports and on-canvas modification of design constructs in a design environment.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present disclosure.

FIG. 2 illustrates a pipeline of generating and refining a design construct using a generative artificial intelligence model, according to some embodiments.

FIG. 3 is a flow diagram of method steps for generating and refining a design construct using a generative artificial intelligence model, according to some embodiments.

FIG. 4 illustrates a network computing system to implement an interactive graphic application platform, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

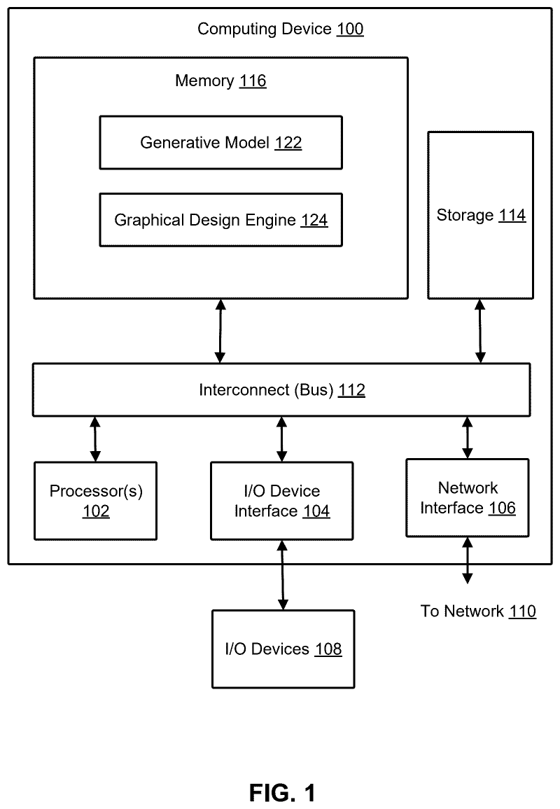

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a generative model 122 and a graphical design engine 124 that reside in a memory 116.

It is noted that the computing device described herein is illustrative and that any other technically feasible configurations fall within the scope of the present disclosure. For example, multiple instances of generative model 122 or graphical design engine 124 could execute on a set of nodes in a distributed and/or cloud computing system to implement the functionality of computing device 100. In another example, generative model 122 or graphical design engine 124 could execute on various sets of hardware, types of devices, or environments to adapt generative model 122 or graphical design engine 124 to different use cases or applications. In a third example, generative model 122 or graphical design engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Generative model 122 and graphical design engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including generative model 122 or graphical design engine 124.

### Example Generating Design Constructs Using Generative Artificial Intelligence Models

Generally, the creation of a design construct (e.g., a custom design construct) in a design environment involves various processing steps performed using various devices with computing capabilities. For example, an image of some artwork (e.g., strokes of a paintbrush) is first captured (e.g., via an image capture device such as a digital camera, scanner, etc.) and converted into a digital format. The captured image is generally a raster image and may be imported into an application and converted into a vector image via a process called “vectorization” or “image tracing.” In some cases, such a raster image is pre-captured, pre-generated, or otherwise made available for various types of downstream graphical design processing. Since a raster image is defined in terms of pixels in absolute locations and loses fidelity when resized, a rasterized source image is generally vectorized, where the vector image is defined in terms of mathematical relationships between different components in a vector image that remain constant when resized In such a manner, when a resulting design construct is applied and manipulated in a design environment, visual fidelity is maintained.

A vectorization application may be hosted on a remote device/system (e.g., as a remote web application accessible over the Internet) or on a local device/system (e.g., as a desktop application). The vector image may then be imported into the graphical design software to be deployed as a custom design construct. In some cases, the graphical design software may include the vectorization functionality and the captured image may directly be imported into the graphical design software and be vectorized therein. Similar to the vectorization application above, the graphical design software may be hosted on a remote device/system or local device/system.

Because the process to create a custom design construct involves various processing steps using various computing devices and/or other devices coupled therewith, the process may have a significant overhead in use of resources, such as compute resources (e.g., GPU/CPU cycles, memory, etc.) and power. Furthermore, such a process is an inherently iterative process given the nature of graphical design tasks. Specifically, a deployed custom design construct is often recreated repeatedly to refine the visual appearance of the visual assets created using the deployed custom design construct. As such, the compute resource usage involved in such a process is often amplified by the iterative nature of the process and may cause a significant waste of compute resources that could be used for other purposes.

Various embodiments described herein use generative artificial intelligence models (e.g., the generative model 122) to generate a custom design construct based on visual properties of the design construct that are specified in various ways. For example, the visual properties of the design construct may be provided in a natural language text prompt, extracted from an input image, obtained from a combination of such a prompt and the visual properties extracted from such an image, translated from interactions (e.g., clickstream data, visual tracking data, etc.) with interactive elements in a user interface, or combinations thereof. A generative artificial intelligence model generally is an artificial intelligence model that generates content in response to an input prompt specifying parameters based on which the generative artificial intelligence model generates the content. Generative artificial intelligence models can generate content in any of a variety of modalities, such as textual content, image content, or other types of content. Some generative artificial intelligence models (e.g., diffusion models) can generate image content in response to a text prompt, an image input, or a combination of a text prompt and an image input. The generative model 122 may be implemented as one or more diffusion models.

Generative artificial intelligence models can generate custom design constructs according to input prompts defining the visual properties of the design construct. A visual property of a custom design construct, as used herein, defines an aspect associated with the design construct that effects a particular visual appearance of the visual assets to be created or modified by the design construct. For example, a visual property of a custom design construct may define a property of the design construct itself, a property external to the design construct that affects one or more visual characteristics of the visual assets to be created by the design construct, a visual characteristic of the visual assets to be created by the design construct. In the graphical design engine 124, visual properties may be specified in a natural language input prompt, translated from values specified in a user interface, and/or inferred from a raster image.

Based on the specified visual properties of a custom design construct, the generative model 122 may generate an intermediate design construct (e.g., as a raster image). The graphical design engine 124 may present the intermediate design construct and allow for further refinements to the visual properties in a user interface of the graphical design engine 124. In such a manner, the intermediate design construct functions as a simulated custom design construct to allow for a determination of whether the specified visual properties are satisfactory and a determination of whether further refinements are needed. The graphical design engine 124 may allow for vectorizing the finalized intermediate design construct and deploying the vectorized intermediate design construct as a custom design construct for creating and modifying visual assets.

Because embodiments of the present disclosure allow for generation and refinement of custom design constructs within a single application (i.e., the graphical design engine 124), the overhead in use of compute resources (e.g., GPU/CPU cycles) can be significantly reduced and the compute resources that would otherwise have been wasted (as discussed above) can be used for other purposes.

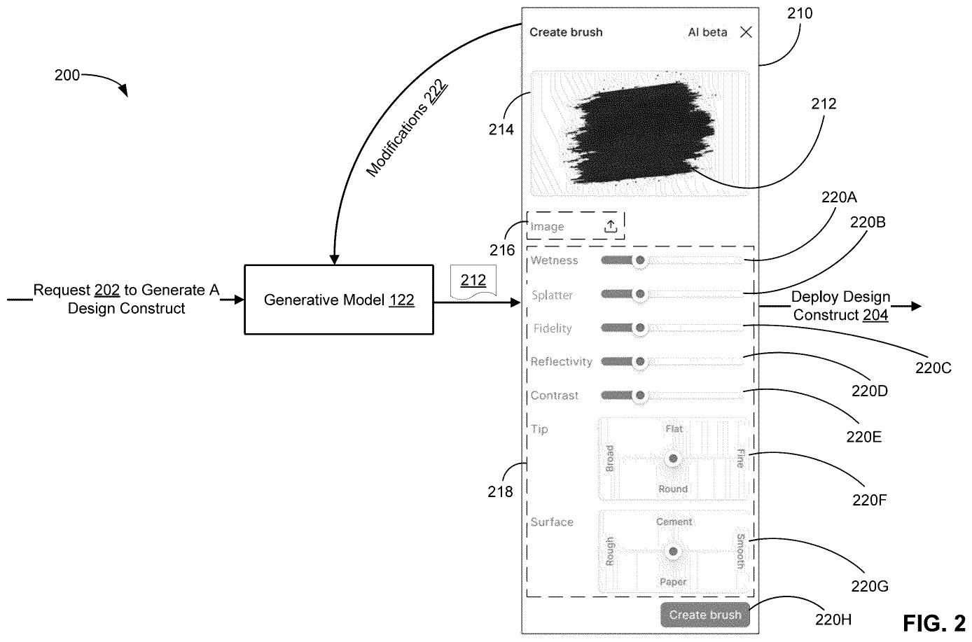

FIG. 2 illustrates an example process 200 of generating and refining a design construct (e.g., a custom design construct) using a generative artificial intelligence model (e.g., the generative model 122 illustrated in FIG. 1), according to some embodiments.

In some embodiments, the generative model 122 may be implemented as a diffusion model trained on a corpus of design-related training data that generates an output image (e.g., a raster image) based on an input prompt specifying the visual properties of a desired design construct based on a denoising process. A visual property of a design construct may define an aspect associated with the design construct that affects a particular visual appearance of the visual assets to be created or modified by the design construct. For example, a visual property of a design construct may define a property of the design construct itself, a property external to the design construct that affects one or more visual characteristics of the visual assets to be created by the design construct, a visual characteristic of the visual assets to be created by the design construct, or the like. Various examples of visual properties are described below in the discussion of interactive elements 220A-G in an interface 210.

In the above-mentioned embodiments, given a natural language specification of one or more visual properties of a design construct, the generative model 122 may be trained to output a raster image illustrating a simulated result of applying a design construct with the specified one or more visual properties on a canvas. Such an output raster image may also be herein referred to as an intermediate design construct for the design construct. For example, as illustrated, a raster image 212 is rendered in the interface 210 illustrating a simulated result of applying a to-be-generated paintbrush on a canvas in the graphical design engine 124. Specifically, the raster image 212 illustrates an image of simulated strokes of the paintbrush on the canvas.

In some embodiments, the generative model 122 may be implemented as a diffusion model that can ingest a variety of data modalities as input (e.g., text, image data, audio data, user activity tracking data, etc.) and generate an output image. For example, given an input raster image, the model can extract visual properties from the image and generate an output raster image that confirm to the extracted visual properties. As another example, the model can accept, as input, an input raster image and an input text prompt specifying the desired visual appearance of an output raster image in relation to the input raster image. In a first case of this example, the input text prompt can express a desire to generate an output raster image that is similar to the input raster image without explicitly referring to any visual properties. In a second case of this example, the input prompt can express a desire to generate an output raster image that is similar to the input raster image but also a desire to adjust one or more visual properties of the input raster image.

As illustrated, the generative model 122 may receive, as input, a request 202 to generate a design construct 204 applicable to visual assets on a canvas in a design environment hosted by the graphical design engine 124 illustrated in FIG. 1. The request 202 may be a natural language text prompt input into a text input field in an interface (e.g., a text input field (not shown) in an interface 210 in FIG. 2 or a separate interface (not shown)). The natural language text prompt input may specify one or more visual properties of the design construct 204. For example, the request 202 may specify that the desired output of the generative model 222 has the appearance of a paintbrush with a defined amount of wetness, splatter, etc. The wetness visual property may be a visual property that defines the degree of an appearance of wetness exhibited by the visual assets created by the paintbrush (e.g., whether a visual asset created by the paintbrush appears as if the visual asset was created by a paintbrush with a large amount of paint on the brush or with a small amount of paint on the brush). The splatter visual property may be a visual property that defines the amount of splatter that would be caused by a stroke of the paintbrush. It should be understood that these are examples of the visual properties of a design construct that can be generated using a generative model, and other modifiable visual properties may also be contemplated.

Given the request 202, the generative model 122 may generate the raster image 212, as output, and provide the raster image 212 for rendering in an interface. The raster image 212 may be a rasterized version of the design construct 204 and may be treated as an intermediate design construct. Once any modifications to the raster image 212 are completed, the intermediate design construct is vectorized and deployed to a design environment, as discussed in further detail herein. As illustrated, the generative model 122 provides the raster image 212 to the interface 210 for rendering in a display panel 214 therein. Continuing with the paintbrush example above, the interface 210 is a user interface for generating a paintbrush for the graphical design engine 124. The raster image 212 is a simulated result of applying the to-be-generated paintbrush on a canvas in the graphical design engine 124.

One or more modifications may be made to the visual appearance of the raster image 212 via a control panel 218 in the interface 210. The control panel 218 may include various interactive elements that correspond to various visual properties of the design construct 204. As illustrated, the control panel 218 includes interactive elements 220A-G that correspond to various visual properties of the to-be-generated paintbrush, which are discussed in greater details below.

Interactions with one or more of the interactive elements 220A-G may be translated to values used to modify the corresponding visual properties. In some embodiments, such values may be adjustments to the current values associated with the visual properties. In some embodiments, such values may be values that replace the current values associated with the visual properties. Continuing with the paintbrush example above, for example, as illustrated, the interactive element 220A is an interactive slider that allows for specifying a value for the wetness visual property of the to-be-generated paintbrush.

As illustrated, other “interactive slider” interactive elements 220B-E are provided in the control panel 218. The interactive element 220C corresponds to a fidelity visual property that defines the fidelity of visual assets created by the to-be-generated paintbrush. The interactive element 220D corresponds to a reflectivity visual property that defines how much light is reflected by the visual assets created by the to-be-generated paintbrush. The interactive element 220E corresponds to a contrast visual property that defines the amount of differences between different colors of the visual assets created by the to-be-generated paintbrush.

As another example, as illustrated, the interactive element 220G is a multidimensional control that allows for specifying multiple visual properties of the to-be-generated paintbrush in the same element. For example, the interactive element 220G may allow for specifying, as one visual property, whether the visual assets created by the to-be-generated paintbrush should have a visual appearance of the paintbrush being applied to a paper surface or a cement surface. The interactive element 220G may also allow for specifying, as another visual property, the degree of the smoothness or roughness of the selected paper or cement surface.

As yet another example, as illustrated, the interactive element 220F is another multidimensional control that allows for specifying multiple visual properties of the to-be-generated paintbrush in the same element. For example, the interactive element 220F may allow for specifying, as two different visual properties, whether the tip of the to-be-generated paintbrush is flat or round and whether the tip is a fine tip that generates a narrower stroke or a broad tip that generates a wider stroke.

It should be understood that the paintbrush described herein is an illustrative design construct and the illustrated visual properties of the paintbrush are also for illustrative purposes. There are various visual properties can be specified in the control panel 218 via various suitable interactive elements. For example, text-related visual properties may include various typeface styles (e.g., whether a typeface is serifed or sans serifed), whether text should have a calligraphic look, and the like. Non-textual visual properties may include properties external to a design construct that affect the visual characteristic(s) of the visual assets created by the design construct, such as lighting, perspective, surface on which the design construct is applied, and the like. Non-textual visual properties may also include visual properties that describe some overarching visual characteristics of the visual assets created by the design construct, such as fidelity, level of realism, a particular regional influence (e.g., eastern v. western style), and the like.

Given the specified values of the visual properties of the design construct 204, the graphical design engine 124 may translate the values to a natural language specification of the visual properties. As illustrated, such a natural language specification of the visual properties is provided, as modifications 222 to these visual properties, to the generative model 122.

Given the modifications 222, the generative model 122 may regenerate the raster image 212 (as an updated image or a new image) and provide the raster image 212 for rendering in the interface 210. In some embodiments, a natural language specification of a subset of the modified visual properties may be provided to the generative model 122 for the regeneration of the raster image 212 and the remaining modified visual properties may be applied to the regenerated raster image 212 (e.g., using programmatic image manipulation techniques) before the regenerated raster image 212 is rendered in the interface 210. In such a manner, any desirable number of iterations of modifying/refining visual properties of the design construct 204 and regenerating the raster image 212 may be allowed by the graphical design engine 124 (e.g., via the interface 210) working in concert with the generative model 122.

Referring now back to the discussion above regarding the request 202, while the request 202 may be a natural language text prompt input into a text input field in an interface, the natural language specification of the modified visual properties of the design construct 204 described above may also serve as a request 202. In some embodiments, a text input field in an interface is not provided for a natural language text prompt to be input as the request 202. Instead, a natural language specification of the visual properties translated from interactions with the interactive elements in an interface (e.g., the control panel 218 in the interface 210) may serve as a request 202. Such a request 202 may be used to initiate the initial generation of the raster image 212 and regeneration of the raster image 212.

In some embodiments, an input raster image may be provided, as a request 202 or as part of a request 202, to the generative model 122. In response, the generative model 122 may extract visual properties from the input raster image and generate an output raster image with the extracted visual properties. For example, as illustrated, a file upload element 216 is provided in the interface 210 to allow for uploading of input raster images. An uploaded input raster image may be provided to the generative model 122 as a request 202 for the generation of the raster image 212. In such embodiments, the control panel 218 may be greyed out or otherwise disabled because the visual properties are extracted from the input raster image rather than explicitly specified. In some embodiments, the control panel 218 may be hidden. After the raster image 212 is generated based on the input raster image, the control panel 218 may be enabled or otherwise made available to allow for interactions with the interactive elements in the control panel 218.

Returning now to the discussion of modifying/refining visual properties of the design construct 204 and regenerating the raster image 212, in some embodiments, the display panel 214 may be implemented as a temporary canvas that allows for a vectorized version of the raster image 212 being deployed therein and interactions with the vectorized version of the raster image 212. Such a temporary canvas functions as sandboxed test environment for the raster image 212 to allow for realistic simulation of user experience of applying the to-be-generated design construct 204 on a canvas. For example, an end-user (e.g., a designer) may be able to create or modify visual assets on the temporary canvas using a generated design construct deployed to the sandboxed test environment based on the vectorized version of the raster image 212. In some embodiments, such a temporary canvas is implemented separately (now shown) from the display panel 214. In such embodiments, the raster image 212 in the display panel 214 stays unchanged while the generated design construct based on the vectorized version of the raster image 212 is being applied in the temporary canvas.

When the raster image 212 is considered satisfactory (e.g., by an end-user, such as a designer), the raster image 212 may be vectorized and deployed, as the design construct 204, to the graphical design engine 124. For example, as illustrated, an interactive element 220H is an interactive button provided in the interface 210 that allows for the vectorization of the raster image 212 and in turn deployment of the vectorized version of the raster image 212 as a paintbrush to the graphical design engine 124. In some embodiments, the generated design construct deployed to the sandboxed test environment, as described above, may be deployed to the graphical design engine 124 directly from the sandboxed test environment.

In response to being deployed to the graphical design engine 124, the design construct 204 may be applied on a canvas of the graphical design engine 124. In some cases, the design construct 204 can be applied to create a visual asset on the canvas. In some cases, the design construct 204 can be applied to modify an extant visual asset on the canvas.

In some embodiments, design constructs may be associated with various tools provided by graphical design engine 124 for creating visual assets on a canvas. Based on the tool with which a design construct is associated, various effects may be implemented for visual assets that use the design construct. For example, a design construct associated with a line drawing tool or other vector image-based tool may allow for customization of a design construct using conversion of a raster image to a vector image that stretches and contracts based on the size of the visual asset, customization based on repetition of the design construct as the size of the visual asset changes, or the like. In another example, a design construct associated with a content filling tool (e.g., a paintbrush or paint bucket tool) may allow for repetition, patterning, and/or tiling effects to be implemented. It should be recognized that the foregoing are but examples of effects that can be implemented with respect to a design construct based on the tool with which a design construct is associated, and other effects may be contemplated.

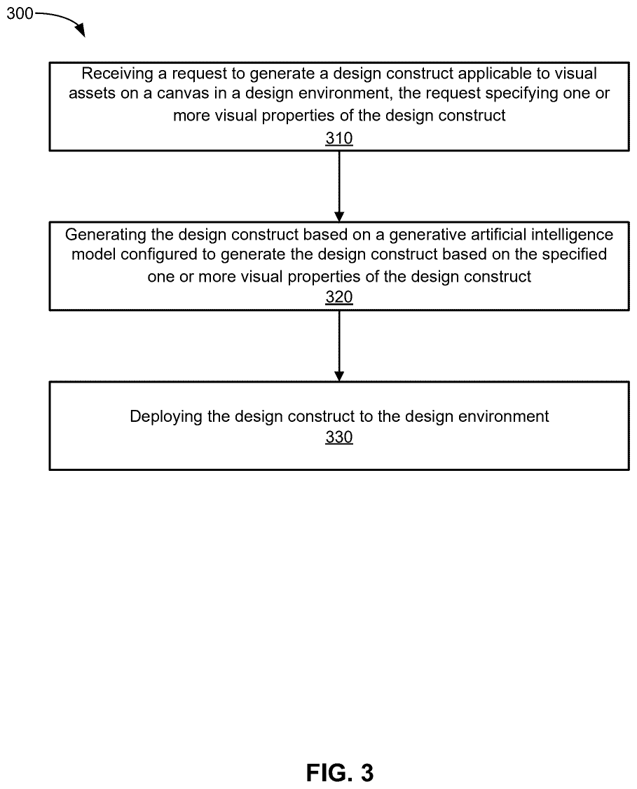

FIG. 3 is a flow diagram illustrating example operations 300 for generating and refining a design construct using a generative artificial intelligence model (e.g., the generative model 122 illustrated in FIG. 1), according to some embodiments. The operations 300 may be performed, for example, by a computing system including one or more processors, such as the processor(s) 102 of the computing device 100 illustrated in FIG. 1, on which one or more of the generative model 122 and/or graphical design engine 124 execute.

As illustrated, the operations 300 may begin at block 310, in which the generative artificial intelligence model 122 receives a request to generate a design construct applicable to visual assets on a canvas in a design environment. The request may specify one or more visual properties of the design construct.

In some embodiments, the request comprises one or more of a natural language specification of the one or more visual properties or an image illustrating at least one of the one or more visual properties. For example, such an image may be a raster image captured using an image capture device. As another example, such an image may be pre-captured, pre-generated, or otherwise made available for various types of downstream graphical design processing.

In some embodiments, the operations 300 further include the generative artificial intelligence model 122 and/or graphical design engine 124 generating the natural language specification of the one or more visual properties based on a translation from user input specifying values for the one or more visual properties input in a control panel. For example, the control panel may be provided in a user interface and may include various interactive elements that correspond to various visual properties of the design construct. Interactions with such interactive elements may be translated to values used to define or modify the corresponding visual properties. Such values may be translated to a natural language specification of the corresponding visual properties.

At block 320, the operations 300 proceed with the generative artificial intelligence model 122 generating the design construct based on a generative artificial intelligence model configured to generate the design construct based on the specified one or more visual properties of the design construct.

In some embodiments, generating the design construct comprises generating, using the generative artificial intelligence model, an intermediate design construct based on the specified one or more visual properties of the design construct in the received request. For example, the intermediate design construct may be a rasterized version of the design construct (e.g., a raster image). One or more modifications may be received to apply to the intermediate design construct, and the design construct may be generated based on applying one or more modifications to the intermediate design construct. In some embodiments, the one or more modifications comprise modifications to an appearance of the intermediate design construct specified by values of one or more interactive elements of a control panel. In some embodiments, the one or more modifications are specified in a natural language prompt defining modifications to apply to the intermediate design construct.

In some embodiments, the operations 300 further include the generative artificial intelligence model 122 and/or graphical design engine 124 deploying the intermediate design construct to a temporary canvas in the design environment. One or more visual assets may be rendered on the temporary canvas based on the intermediate design construct. The temporary canvas may correspond to a sandboxed test environment for the intermediate design construct.

In some embodiments, generating the design construct comprises generating, using the generative artificial intelligence model, a rasterized version of the design construct. The rasterized version of the design construct may be vectorized.

At block 330, the operations 300 proceed with the generative artificial intelligence model 122 deploying the design construct to the design environment (e.g., hosted by graphical design engine 124 illustrated in FIG. 1). In some embodiments, the operations 300 further include creating a visual asset on the canvas in the environment based on an application of the deployed design construct on the canvas. In some embodiments, the operations 300 further include modifying an extant visual asset on the canvas in the environment based on an application of the deployed design construct to the extant visual asset.

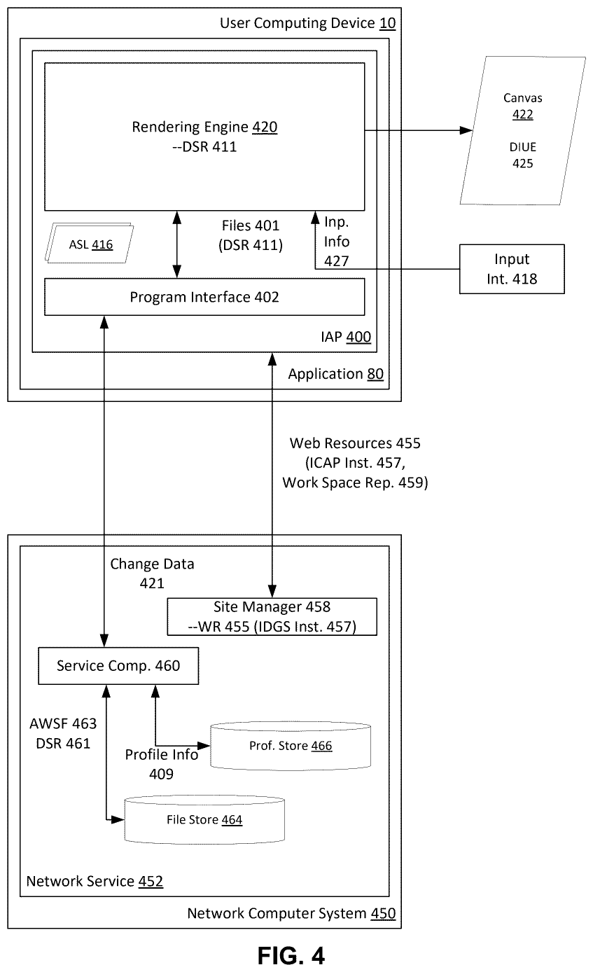

FIG. 4 illustrates a network computing system to implement an interactive application platform on a user computing device, according to some embodiments. A network computing system such as illustrated in FIG. 4 can be implemented using one or more servers which communicate with user computing devices over one or more networks. The network computer system 450 illustrated in FIG. 4 may correspond, for example, to the computing device 100 illustrated in FIG. 1 and can be used to generate and/or modify visual content based on generative artificial intelligence models and an input prompt specifying a design objective for the visual content.

In some embodiments, the network computing system 450 performs operations to enable an interactive application platform (“IAP 400”) to be implemented on user computing devices 10. In some embodiments, the IAP 400 can be implemented by the user initiating a session (e.g., user accessing a website) to receive programmatic resources of the IAP 400. A browser component executes the programmatic resources to implement the IAP 400, with functionality to receive user input and to render content that is based on or responsive to user input. As described, the IAP 400 is implemented to enable the user to create various types of content, such as interactive graphic designs, art, whiteboard content, program code renderings, presentations, and/or textual content. As further described, the IAP 400 can include logic (“ASL 416”) for implementing one or more application services, where each application service is implemented through the IAP 400 to provide a corresponding set of functionality and user experience. The IAP 400 also implements the application services to share some resources, such as the canvas, workspace file or library of design elements. Further, the IAP 400 enables multiple application services to be used during a given online session and/or with respect to a particular application service.

According to some embodiments, a user of computing device 10 operates web-based application 80 to access a network site, where programmatic resources are retrieved and executed to implement the IAP 400. The web-based application 80 can execute scripts, code and/or other logic (the “programmatic components”) to implement functionality of the IAP 400. In some embodiments, the web-based application 80 can correspond to a commercially available browser, such as GOOGLE CHROME (developed by GOOGLE, INC.) or SAFARI (developed by APPLE, INC.). In some embodiments, the processes of the IAP 400 can be implemented as scripts and/or other embedded code which web-based application 80 downloads from a network site. For example, the web-based application 80 can execute code that is embedded within a webpage to implement processes of the IAP 400. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some embodiments, the rendering engine 420 may utilize graphics processing unit (GPU) accelerated logic, such as provided through WebGL (Web Graphics Library) programs which execute Graphics Library Shader Language (GLSL) programs that execute on GPUs.

The IAP 400 can be implemented as part of a network service, where web-based application 80 communicates with one or more remote computers (e.g., server used for a network service) to execute processes of the IAP 400. The web-based application 80 retrieves some or all of the programmatic resources for implementing the IAP 400 from a network site. The web-based application 80 may also access various types of data sets in providing the IAP 400. The data sets can correspond to files and design libraries (e.g., predesigned design elements), which can be stored remotely (e.g., on a server, in association with an account) or locally. In some embodiments, the network computer system 450 provides a shared design library which the user computing device 10 can use with any of the application services provided through the IAP 400. In this way, the user may initiate a session to implement the IAP 400 for the purpose of creating or editing the workspace file, as rendered on the canvas 422, in accordance with one of multiple collaborative application services of the IAP 400.

In some embodiments, the IAP 400 includes a program interface 402, an input interface 418 and a rendering engine 420. The program interface 402 can include one or more processes which execute to access and retrieve programmatic resources from local and/or remote sources. In an implementation, the program interface 402 can generate, for example, a canvas 422, using programmatic resources which are associated with web-based application 80 (e.g., HTML 5.0 canvas). As an addition or variation, the program interface 402 can trigger or otherwise cause the canvas 422 to be generated using programmatic resources and data sets (e.g., canvas parameters) which are retrieved from local (e.g., memory) or remote sources (e.g., from network service).

The program interface 402 may also retrieve programmatic resources that include an application framework for use with canvas 422. The application framework can include data sets which define or configure, for example, a set of interactive graphic tools that integrate with the canvas 422 and which comprise the input interface 418, to enable the user to provide input to generate or update content rendered on the canvas 422.

According to some embodiments, the input interface 418 can be implemented as a functional layer that is integrated with the canvas 422 to detect and interpret user input. The input interface 418 can, for example, process a user's interaction with an input mechanism (e.g., pointer device, keyboard) of the user computing device, to detect, for example, cursor positioning/movement with respect to the canvas 422, hover input (e.g., pre-selection input), selection input (e.g., clicks or double clicks), shortcuts (e.g., key board inputs) and other inputs. In processing a user's interaction with a pointer device, the input interface 418 can use a reference of the canvas 422 to identify a screen location of a user's cursor as the user moves or otherwise interacts with the pointer device. Additionally, the input interface 418 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In some embodiments, the input interface 418 can interpret, for example, a series of inputs as a design tool selection (e.g., shape selection based on location of input), as well as inputs to define attributes (e.g., dimensions) of a selected shape. In some embodiments, the input interface 418 can interpret a continuous input (corresponding to a continuous movement of the user's pointer device) as selecting a tool (e.g., shape too) and canvas location where an output of the selected tool is to appear.

In some embodiments, the IAP 400 includes application service logic 416 to enable multiple application services to be utilized during a given user session, where each application service provides the user with a particular functionality and/or user experience. As described by some embodiments, each application service is implemented by the IAP 400 utilizing a corresponding application service logic 416 to configure the interface component 418, rendering engine 420 and/or other components of the IAP 400 to provide the functionality and user experience of the corresponding application service. In this way, the IAP 400 enables the user to operate multiple application services during one online session. Further, the different application services can share resources, including programmatic resources of the IAP 400, such as canvas 422. In this way, each application service can contribute content to and/or utilize features and content provided with the canvas 422 during a given session. Still further, the application services can be implemented as alternative modalities of IAP 400, such that the user can toggle between modes, where each mode provides a particular functionality and user experience. In some embodiments, each application service can utilize a common workspace file associated with the user. By default, a computing device that opens the workspace file can utilize a default application service to access and/or update that workspace file. The user may also switch the mode of operation of the IAP 400 to utilize a different application service to access, use and/or update the workspace file.

The network computing system 450 can include a site manager 458 to manage a website where a set of web-resources 455 (e.g., web page) are made available for the web-based application 80 of user computing devices 10. The web-resources 455 can include instructions, such as scripts or other logic (“ICAP instructions 457”), which are executable by browsers or web components of user computing devices. The web resources 455 can also include (i) resources that are to be shared as between application services, provided to the user computing devices in connection with the user computing devices utilizing either of the application services, and (ii) application specific resources, which execute on the user computing devices for a particular one of the available application services. The web resources 455 can also include a design library of design elements that is partially or fully shared as between the application services. The library of design elements can enable the user to select predetermined design elements for use on the canvas 422 in connection with the user utilizing either of the application services.

In some variations, once the computing device 10 accesses and downloads the web-resources 455, web-based application 80 executes the IAP instructions 457 to implement functionality as described above. For example, the IAP instructions 457 can be executed by web-based application 80 to initiate the program interface 402 on the user computing device 10. The initiation of the program interface 402 may coincide with the establishment of, for example, a web-socket connection between the program interface 402 and a service component 460 of the network computing system 450.

In some embodiments, the web-resources 455 includes logic which web-based application 80 executes to initiate one or more processes of a program interface 402, causing the IAP 400 to retrieve additional programmatic resources and data sets for implementing functionality as described by examples. The web resources 455 can, for example, embed logic (e.g., JAVASCRIPT code), including GPU accelerated logic, in an HTML page for download by computing devices of users. The program interface 402 can be triggered to retrieve additional programmatic resources and data sets from, for example, the network service 452, and/or from local resources of the computing device 10, in order to implement each of the multiple application services of the IAP 400. For example, some of the components of the IAP 400 can be implemented through webpages that can be downloaded onto the computing device 10 after authentication is performed, and/or once the user performs additional actions (e.g., download one or more pages of the workspace associated with the account identifier). Accordingly, in examples as described, the network computing system 450 can communicate the IAP instructions 457 to the computing device 10 through a combination of network communications, including through downloading activity of web-based application 80, where the IAP instructions 457 are received and executed by web-based application 80.

The computing device 10 can use web-based application 80 to access a website of the network service 452 to download the webpage or web resource. Upon accessing the website, web-based application 80 can automatically (e.g., through saved credentials) or through manual input, communicate an account identifier to the service component 460. In some embodiments, web-based application 80 can also communicate one or more additional identifiers that correlate to a user identifier.

Additionally, in some embodiments, the service component 460 can use the user or account identifier of the user identifier to retrieve profile information 409 from a user profile store 466. As an addition or variation, profile information 409 for the user can be determined and stored locally on the user's computing device 10.

The service component 460 can also retrieve the files of an active workspace (“active workspace files 463”) that are linked to the user account or identifier from a file store 464. The profile store 466 can also identify the workspace that is identified with the account and/or user, and the file store 464 can store the data sets that comprise the workspace. The data sets stored with the file store 464 can include, for example, the pages of a workspace and one or more data structure representations 461 for the design under edit which is renderable from the respective active workspace files.

As an addition or variation, each file can be associated with metadata that identifies the application service that was used to create the particular file. In some embodiments, the metadata identifies the default application service for viewing, utilizing or otherwise updating the application service.

Additionally, in some embodiments, the service component 460 provides a representation 459 of the workspace associated with the user to the web-based application 80, where the representation identifies, for example, individual files associated with the user and/or user account. The workspace representation 459 can also identify a set of files, where each file includes one or multiple pages, and each page including objects that are part of a design interface.

On the user device 10, the user can view the workspace representation through web-based application 80, and the user can elect to open a file of the workspace through web-based application 80. In some embodiments, upon the user electing to open one of the active workspace files 463, web-based application 80 initiates the canvas 422. For example, the IAP 400 can initiate an HTML 5.0 canvas as a component of web-based application 80, and the rendering engine 420 can access one or more data structures representations 411 of content rendered on the canvas 422.

The IAP 400 utilizes application service logic 416 to implement multiple modes of operation, where each mode corresponds to an application service. As described, the application service logic 416 associated with each service application can include instructions and data for configuring the components of IAP 400 to include functionality and features of the corresponding application service. Accordingly, the application service logic 416 can, for example, configure the application framework and/or input interface 418 to differ in form, functionality and/or configuration as between the alternative modes of the IAP 400. Additionally, the type of actions and interactions which the user can perform to register input can vary based on the modes of operation. Still further, the different modes of operation can include different input or user-interface features for the user to select and use for inclusion on the canvas 422. By way of example, when the IAP 400 is operating in a mode for whiteboarding service application, the program interface 402 can provide input features to enable a user to select a design element that is in the form of a “sticky note,” while in an alternative mode for an interactive graphic design service application, the “sticky note feature” is not available. However, in the alternative mode, the user may be able to select anyone of numerous possible shapes or previously designed objects which the user can write textual messages in for display on the canvas 422.

Additionally, the application service logic 416 can configure the operation of the rendering engine 420, such that the functionality and behavior of the rendering engine 420 differs as between different application services. In this way, the rendering engine 420 functions to provide alternative behaviors for different modes of operation, coinciding with the particular service application that is active. By way of example, the configuration of the rendering engine 420 can affect the appearance of the canvas 422, the appearance (e.g., visual attributes) of rendered content elements on the canvas 422, the behavior or representation of user interaction (e.g., whether the user cursor or pointe device is represented on the canvas 422), the type or specific content that is rendered, the physic engine that is used by the rendering engine to represent dynamic events (e.g., the object being moved), what user operations can be performed (e.g., whether select objects can be resized), and the like.

Additionally, each of the application services can utilize a shared library of content elements (e.g., graphic design element), as well as core functionality that enables design elements to be shared and updated between the different application services that are available through the platform. Additionally, the workspace file created and edited through use of one application service can be utilized with the other application service. Moreover, the transition between application services can be seamless—for example, the user computing device 10 can open a workspace file using the first application service (e.g., interactive graphic design application service for UIX design) then seamlessly switch to using the second application service (e.g., whiteboarding application service) with the same file, without closing the workspace file. In some embodiments, each application service enables the user to update the workspace file even while the workspace file is in use by other computing devices (e.g., such as in a collaborative environment). In some embodiments, the user can mode switch the IAP 400 to switch which application service is in use, with each application service utilizing the workspace file.

### Example Clauses

Various aspects of the present disclosure are described in the following numbered clauses.
1: In some embodiments, a processor-implemented method, comprising: receiving a request to generate a design construct applicable to visual assets on a canvas in a design environment, the request specifying one or more visual properties of the design construct; generating the design construct based on a generative artificial intelligence model that generates the design construct based on the specified one or more visual properties of the design construct; and deploying the design construct to the design environment.
2: The method of clause 1, wherein generating the design construct comprises: generating, using the generative artificial intelligence model, an intermediate design construct based on the specified one or more visual properties of the design construct in the received request; receiving one or more modifications to apply to the intermediate design construct; and generating the design construct based on applying one or more modifications to the intermediate design construct.
3: The method of clause 2, wherein the one or more modifications comprise modifications to an appearance of the intermediate design construct specified by values of one or more interactive elements of a control panel.
4: The method of clause 2 or 3, wherein the one or more modifications are specified in a natural language prompt defining modifications to apply to the intermediate design construct.
5: The method of any of clauses 2 through 4, further comprising: deploying the intermediate design construct to a temporary canvas in the design environment, the temporary canvas corresponding to a sandboxed test environment for the intermediate design construct; and rendering one or more visual assets on the temporary canvas based on the intermediate design construct.
6: The method of any of clauses 1 through 5, wherein the request comprises one or more of a natural language specification of the one or more visual properties or an image illustrating at least one of the one or more visual properties.
7: The method of clause 6, further comprising generating the natural language specification of the one or more visual properties based on a translation from user input specifying values for the one or more visual properties input in a control panel.
8: The method of any of clauses 1 through 7, wherein generating the design construct comprises: generating, using the generative artificial intelligence model, a rasterized version of the design construct; and vectorizing the rasterized version of the design construct.
9: The method of any of clauses 1 through 8, further comprising: creating a visual asset on the canvas in the environment based on an application of the deployed design construct on the canvas.
10: The method of any of clauses 1 through 9, further comprising: modifying an extant visual asset on the canvas in the environment based on an application of the deployed design construct to the extant visual asset.
11: A processing system, comprising: at least one memory having executable instructions thereon; and one or more processors configured to execute the executable instructions to cause the processing system to perform the method of any of clauses 1 through 10.
12: A non-transitory computer-readable medium having executable instructions stored thereon which, when processed by one or more processors, causes the one or more processors to perform the method of any of clauses 1 through 10.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving a request to generate a design construct applicable to visual assets on a canvas in a design environment, the request specifying one or more visual properties of the design construct;
generating the design construct based on a generative artificial intelligence model that generates the design construct based on the specified one or more visual properties of the design construct; and
deploying the design construct to the design environment.

2. The method of claim 1, wherein generating the design construct comprises:
generating, using the generative artificial intelligence model, an intermediate design construct based on the specified one or more visual properties of the design construct in the received request;
receiving one or more modifications to apply to the intermediate design construct; and
generating the design construct based on applying one or more modifications to the intermediate design construct.

3. The method of claim 2, wherein the one or more modifications comprise modifications to an appearance of the intermediate design construct specified by values of one or more interactive elements of a control panel.

4. The method of claim 2, wherein the one or more modifications are specified in a natural language prompt defining modifications to apply to the intermediate design construct.

5. The method of claim 2, further comprising:
deploying the intermediate design construct to a temporary canvas in the design environment, the temporary canvas corresponding to a sandboxed test environment for the intermediate design construct; and
rendering one or more visual assets on the temporary canvas based on the intermediate design construct.

6. The method of claim 1, wherein the request comprises one or more of a natural language specification of the one or more visual properties or an image illustrating at least one of the one or more visual properties.

7. The method of claim 6, further comprising generating the natural language specification of the one or more visual properties based on a translation from user input specifying values for the one or more visual properties input in a control panel.

8. The method of claim 1, wherein generating the design construct comprises:
generating, using the generative artificial intelligence model, a rasterized version of the design construct; and
vectorizing the rasterized version of the design construct.

9. The method of claim 1, further comprising:
creating a visual asset on the canvas in the environment based on an application of the deployed design construct on the canvas.

10. The method of claim 1, further comprising:
modifying an extant visual asset on the canvas in the environment based on an application of the deployed design construct to the extant visual asset.

11. A processing system, comprising:
at least one memory having executable instructions stored thereon; and
one or more processors configured to execute the executable instructions to cause the processing system to perform:
receiving a request to generate a design construct applicable to visual assets on a canvas in a design environment, the request specifying one or more visual properties of the design construct;
generating the design construct based on a generative artificial intelligence model that generates the design construct based on the specified one or more visual properties of the design construct; and
deploying the design construct to the design environment.

12. The processing system of claim 11, wherein generating the design construct comprises:
generating, using the generative artificial intelligence model, an intermediate design construct based on the specified one or more visual properties of the design construct in the received request;
receiving one or more modifications to apply to the intermediate design construct; and
generating the design construct based on applying one or more modifications to the intermediate design construct.

13. The processing system of claim 12, wherein the one or more modifications comprise modifications to an appearance of the intermediate design construct specified by values of one or more interactive elements of a control panel.

14. The processing system of claim 12, wherein the one or more modifications are specified in a natural language prompt defining modifications to apply to the intermediate design construct.

15. The processing system of claim 12, wherein the one or more processors are further configured to cause the processing system to perform:
deploying the intermediate design construct to a temporary canvas in the design environment, the temporary canvas corresponding to a sandboxed test environment for the intermediate design construct; and
rendering one or more visual assets on the temporary canvas based on the intermediate design construct.

16. The processing system of claim 11, wherein the request comprises one or more of a natural language specification of the one or more visual properties or an image illustrating at least one of the one or more visual properties.

17. The processing system of claim 16, wherein the one or more processors are further configured to cause the processing system to perform generating the natural language specification of the one or more visual properties based on a translation from user input specifying values for the one or more visual properties input in a control panel.

18. The processing system of claim 11, wherein generating the design construct comprises:
generating, using the generative artificial intelligence model, a rasterized version of the design construct; and
vectorizing the rasterized version of the design construct.

19. The processing system of claim 11, wherein the one or more processors are further configured to cause the processing system to perform:
creating a visual asset on the canvas in the environment based on an application of the deployed design construct on the canvas.

20. The processing system of claim 11, wherein the one or more processors are further configured to cause the processing system to:
modifying an extant visual asset on the canvas in the environment based on an application of the deployed design construct to the extant visual asset.
